(19) United States
(12) Patent Application Publication
(10) Pub. No.: US 2011/0225546 A1
(43) Pub. Date: Sep. 15, 2011

(54) MAP SPOTLIGHTS

(76) Inventor: Gonzalo A. Ramos, Bellevue, WA (US)

(21) Appl. No.: 12/720,503

(22) Filed: Mar. 9, 2010

(51) Int. Cl. G06F 3/048

(52) U.S. Cl. 715/823

(57) ABSTRACT

Various embodiments enable, in a mapping context, various regions containing points of interest to be spotlighted. In at least some embodiments, a map is displayed on a computing device and points of interest can be located on the map. One or more regions containing the points of interest can be visually spotlighted to draw the user's attention to associated regions.

### BACKGROUND

Traditionally, maps have been used to chart the various routes between destinations, as well as landmarks, cities, etc. With the evolution of maps in electronic form and associated software, maps can be rendered with additional information, such as specific addresses, restaurants, gas stations, hotels, businesses, and the like. For example, as a user enters a query for one or more points of interest, an associated map can be updated with the additional points of interest being visually marked.

As a map is populated with more information, it becomes increasingly difficult to present points of interest to the user in an easily discernable way. This is because items on a map can become quite dense and crowded. Thus, a multitude of displayed information can easily occlude what the user is interested in, as well as hinder the user from quickly interacting with map content.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Various embodiments enable, in a mapping context, various regions containing points of interest to be spotlighted. In at least some embodiments, a map is displayed on a computing device and points of interest can be located on the map. One or more regions containing the points of interest can be visually spotlighted to draw the user's attention to associated regions.

In at least some embodiments, spotlighting can include leaving spotlighted regions visually untouched, while visually dimming regions that are not spotlighted. In some embodiments, spotlighting can be achieved through the use of a mask. The mask can be generated to represent a visual distinction between regions of interest and regions that are not of interest. The mask can then be used to render a map that includes spotlighted regions.

Some embodiments can further vary the visual intensity of the spotlight between regions responsive to the region's determined relevance.

### BRIEF DESCRIPTION OF THE DRAWINGS

The same numbers are used throughout the drawings to reference like features.

FIG. 1 illustrates an operating environment in which various principles described herein can be employed in accordance with one or more embodiments.

FIG. 2 illustrates two maps, one rendered without using various principles described herein and one rendered using the various principles described herein.

FIG. 3 is a flow diagram that describes steps in a method in accordance with one or more embodiments.

FIG. 4 illustrates a relationship between a mask and a map with which the mask is associated, in accordance with one or more embodiments.

FIG. 5 is a flow diagram that describes steps in a method in accordance with one or more embodiments.

FIG. 6 illustrates aspects of spotlighting a map in accordance with one or more embodiments.

FIG. 7 is a flow diagram that describes steps in a method in accordance with one or more embodiments.

FIG. 8 illustrates an example system that can be used to implement one or more embodiments.

### DETAILED DESCRIPTION

Overview

Various embodiments enable, in a mapping context, various regions containing points of interest to be spotlighted. In at least some embodiments, a map is displayed and points of interest can be located on the map. One or more regions containing points of interest can be visually spotlighted to draw the user's attention to associated regions. In at least some embodiments, the shape and size of a spotlight can be fixed or variable. In a similar manner, the shape and size of regions containing points of interest can be fixed or variable. For example, depending upon the number of points of interest in an area, the scaling of the map, and the clustering of the points of interest, a region or spotlight may be defined to have an asymmetric shape. In another example, a region or spotlight may be defined to be a fixed circle. Thus, the shape and the size of a region, and its associated spotlight, can vary.

In at least some embodiments, spotlighting can include leaving spotlighted regions visually untouched, while visually dimming region(s) that are not spotlighted. In some embodiments, spotlighting can be achieved through the use of a mask. The mask can be generated to represent a visual distinction between regions of interest and regions that are not of interest. The mask can then be used to render a map that includes spotlighted regions by visually dimming the region(s) that are not of interest.

Some embodiments can further vary the visual intensity of the spotlight between regions corresponding to a region's determined relevance. For example, a filter can be applied to a region to vary the effective visual intensity of a spotlight on the region. The variance of the visual intensity can correspond to a region's relevance. As much as a region's relevance varies, so too can the visual intensity. A different visual intensity can be applied to each region identified in the same rendering.

In the discussion that follows, a section entitled “Operating Environment” is provided and describes one environment in which one or more embodiments can be employed. Following this, a section entitled “Spotlighting a Map” describes how a map can be constructed to spotlight regions of interest in accordance with one or more embodiments. Next, a section entitled “Mask Generation” describes how a mask can be generated and applied to a map to render a map with regions spotlighted in accordance with one or more embodiments. Following this, a section entitled “Graduated Intensity” describes one or more embodiments where the spotlight intensity of one or more regions can be varied to relate the region's relevance to a user. Last, a section entitled “Example System” describes an example system that can be used to implement one or more embodiments.

Consider now an example operating environment in which one or more embodiments can be implemented.

Operating Environment

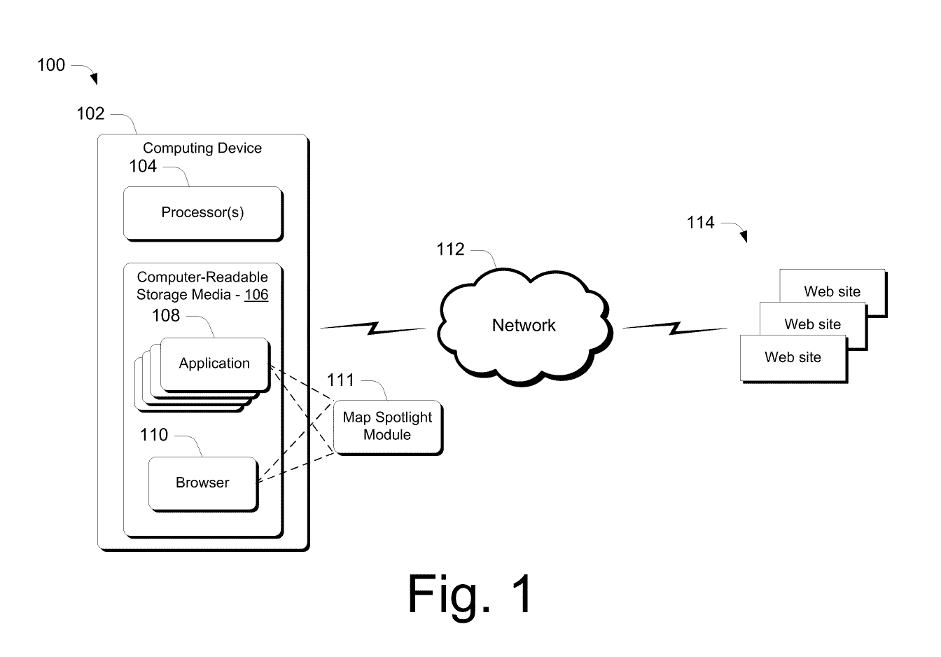

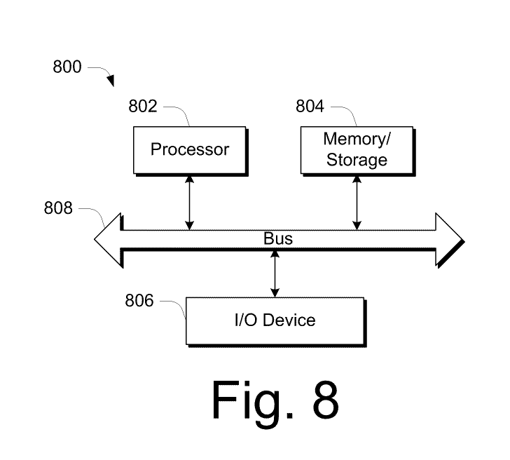

FIG. 1 illustrates an operating environment in accordance with one or more embodiments, generally at 100. Environment 100 includes a computing device 102 having one or more processors 104, one or more computer-readable storage media 106 and one or more applications 108 that reside on the computer-readable storage media and which are executable by the processor(s). The computer-readable storage media can include, by way of example and not limitation, all forms of volatile and non-volatile memory and/or storage media that are typically associated with a computing device. Such media can include ROM, RAM, flash memory, hard disk, removable media and the like. One specific example of a computing device is shown and described below in FIG. 8.

In addition, computing device 102 includes a software application in the form of a web browser 110. Any suitable web browser can be used examples of which are available from the assignee of this document and others. In addition, computer-readable storage media 106 can include a map spotlight module 111 that operates as described above and below. Map spotlight module 111 can be implemented as a standalone component that can be utilized by applications 108 and browser 110. Alternately or additionally, the map spotlight module 111 can be implemented as part of applications 108 and/or browser 110.

In operation, map spotlight module 111 works in a mapping context to enable rendering of a map that draws the user's attention to a region(s) of interest. The map spotlight module can do this by spotlighting the region(s). For example, the map spotlight module can identify a region(s) of interest, and cause the region(s) to be visually brighter than regions not of interest, as described below in more detail.

In addition, environment 100 includes a network 112, such as the Internet, and one or more web sites 114 from and to which content can be received and sent. Such content can include map content that can be operated upon by map spotlight module 111 as described above and below. It is to be appreciated and understood that computing devices, such as servers that support web sites 114, can include map spotlight modules that operate as described above and below.

Computing device 102 can be embodied as any suitable computing device such as, by way of example and not limitation, a desktop computer, a portable computer, a handheld computer such as a personal digital assistant (PDA), cell phone, and the like.

Having described an example operating environment, consider now a discussion of how spotlighting a map can be performed in accordance with one or more embodiments.

Spotlighting a Map

Various embodiments provide the ability to draw a user's attention to one or more regions containing one or more points of interest. A spotlight is used to cause the region(s) to appear visually brighter than regions excluding points of interest. For example, by spotlighting, on a map, the region(s) of interest while not spotlighting regions that exclude point(s) of interest, a user's focus can easily be directed to more relevant region(s).

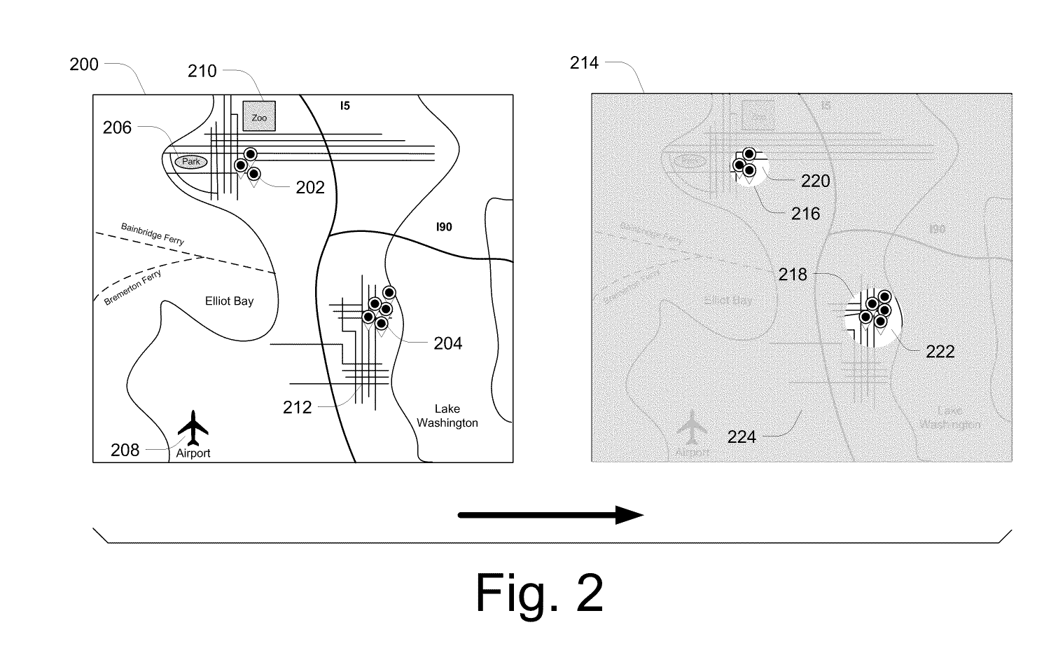

As an example, consider FIG. 2 which illustrates an example map 200 that has been rendered with points of interest marked at 202 and 204. The points of interest can be marked in any suitable way, such as, by way of example and not limitation, an affordance such as a push pin, an “X”, an icon, and the like. In addition to the multiple points of interest, map 200 displays additional visual information, such as the location of a park 206, an airport 208, a zoo 210, as well as various routes 212. Even though the points of interest are marked, a user's attention can become divided between the additional visual information presented and the points of interest.

The points of interest can be identified in any suitable way. As but one example, consider a user reading an article about a city, restaurant, local attraction, or the like. If the user hovers their cursor over a focus of interest in the article, a map can be rendered that spotlights the focus. As another example, a user can input a query into their browser for a location, store, restaurant, and the like. Responsive to the user's input, a map can be rendered that spotlights the location, store, restaurant or the like. It is to be appreciated and understood that points of interest can be generated from input other than from a user. For example, advertisers might designate points of interest that are to be highlighted when a particular map is rendered.

In accordance with one or more embodiments, to draw a user's attention to the points of interest, regions that are ascertained to contain the point(s) of interest are spotlighted, as illustrated by the map 214. Specifically, points of interest 202 and 204 are located on the map in regions 220 and 222 respectively. The shapes of the regions can be defined in any suitable way such as, by way of example and not limitation, a circle, a square, an asymmetrical shape, a rectangle and the like. In one or more embodiment, the size and/or shape of regions can vary from one another in the same rendering, as shown by regions 220 and 222 in which the size of the region is varied. Any suitable considerations can form the basis by which the sizes and/or shapes of the regions can be varied. For example, regions that contain less points of interest might be defined to be smaller than regions that contain more points of interest. Alternatively or additionally, regions that contain a point of interest having a high relevance might be defined to be larger than a region that contains a point of interest with a lower relevance. Thus, multiple region(s) can vary in size and/or shape based upon relevance.

Once the region(s) have been identified, spotlights can be applied as described above and below. Multiple spotlighted region(s) can vary in size and shape. For example, spotlights 216 and 218 are applied to regions 220 and 222 respectively, to make them visually distinctive—in this case brighter, than region 224.

In one or more embodiments, edges of a spotlight can be rendered in a manner to fade a spotlight edge into regions that are not spotlighted. Although not illustrated, this can be done by employing a suitable filter when the spotlight is rendered.

Various embodiments can also provide an ability for spotlights to appear and disappear quickly without interfering with a map's underlying content. In one embodiment, this can be achieved by rendering a corresponding opacity map. For example, reading an article via a browser can activate one or more spotlight regions of a map that the article mentions. Closing the newspaper article can then deactivate the spotlights.

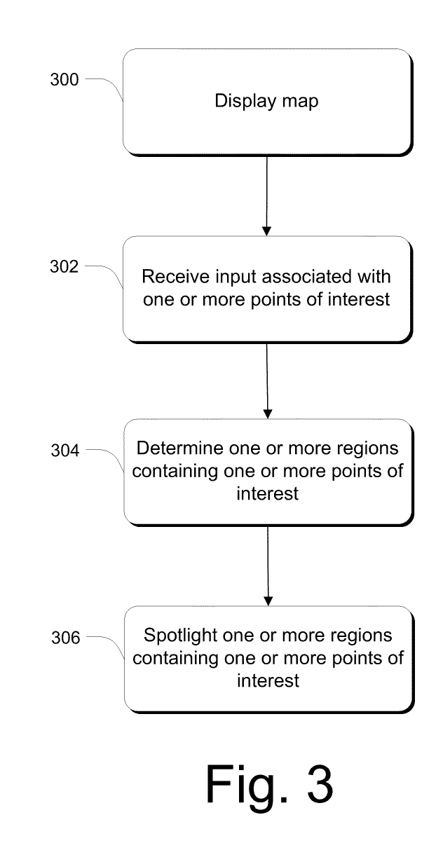

FIG. 3 is a flow diagram that describes steps in a method in accordance with one or more embodiments. The method can be implemented in connection with any suitable hardware, software, firmware or combination thereof. In at least some embodiments, aspects of the method can be implemented by a suitably configured web browser and/or a software module, such as map spotlighting module 111 (FIG. 1). Alternately or additionally, the method can be implemented by a server that serves web pages.

Step 300 displays a map. This step can be performed in any suitable way. For example, in at least some embodiments, the map can be displayed via a web browser or any other suitable software application such as GPS software executing on a computing device. Step 302 receives an input associated with one or more points of interest relative to the map. This input can comprise any suitable type of input, examples of which are provided above.

Responsive to receiving the input, step 304 determines one or more regions, relative to the map, that contain the point(s) of interest. This step can be performed in any suitable way. For example, the regions can be determined based upon the number of points, the scaling of the displayed map, the proximity of the point(s) to one another, whether regions would overlap, and the like. It is to be appreciated and understood, however, that any suitable technique for determining regions that contain points of interest can be utilized without departing from the spirit of the claimed subject matter. This step can result in single or multiple regions being defined.

Responsive to determining the region(s) containing the point(s) of interest, step 306 spotlights the region(s) on a map to create a discernable visual distinction over regions that do not contain points of interest. For example, the spotlights can cause the region(s) of interest to appear brighter relative to region(s) that exclude points of interest. This can be performed in any suitable way. For example, in at least one embodiment, this step can be performed by rendering the region(s) that exclude the point(s) of interest visually dimmer, while the region(s) of interest remain untouched. Spotlighting the map can include updating the existing map, or rendering a new map to contain the spotlights.

Having described how spotlighting a map can be performed in accordance with one or more embodiments, consider now how masks can be employed to provide a spotlighting effect on a map.

Mask Generation

In at least some embodiments, a map can be spotlighted by using a mask. For example, a mask can be used to represent and distinguish between region(s) of interest and region(s) not of interest. The mask can then be used to render a map with the region(s) of interest on the map differing in visual appearance from the region(s) that are not of interest.

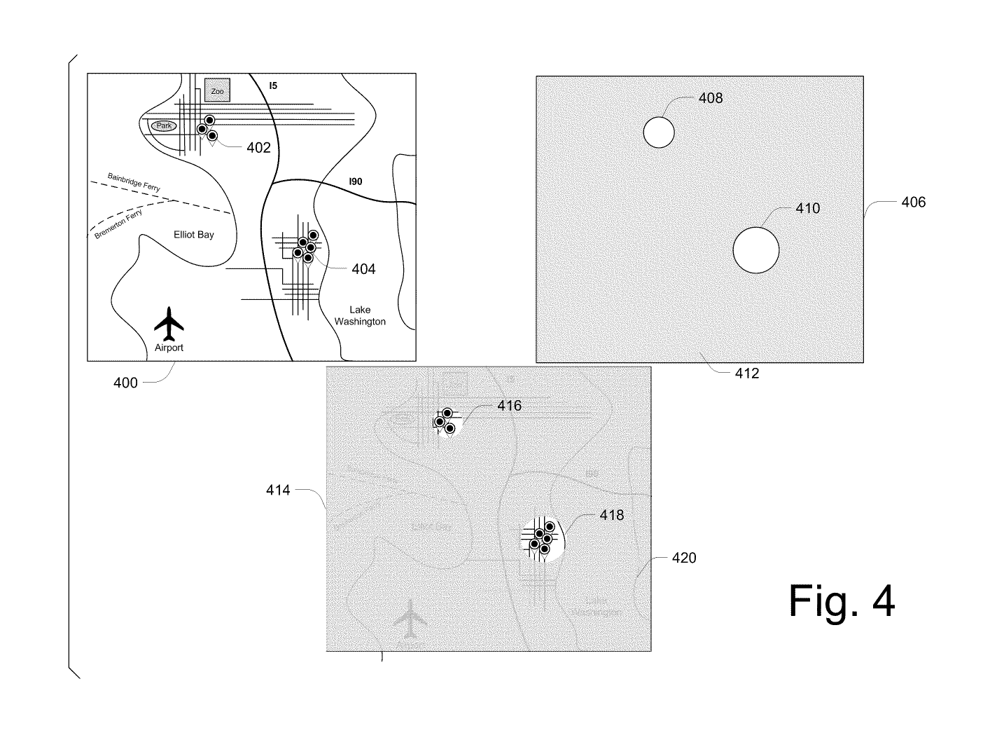

As an example, consider FIG. 4. There, a map 400 has been rendered with points of interest marked at 402 and 404. In addition to the points of interest, map 400 displays extra information, such as routes, a park and a zoo.

Mask 406 includes three distinct regions 408, 410, and 412. Regions 408 and 410 correspond to regions(s) that contain points of interest 402, 404, while region 412 represents a region excluding any points of interest. A mask can contain regions that are separate, as shown in mask 406, regions that overlap, or any combination thereof.

In one or more embodiments, a mask can be represented as a bitmap with a black background that characterizes regions that are not of interest. Regions including points of interest can be included on the bitmap by adding shapes to the bitmap. While mask 406 illustrates regions 408 and 410 as white circular shapes, it is to be appreciated and understood that any suitable shape, size, and color can be used without departing from the spirit of the claimed subject matter. Once formed, the bitmap can then be used as an input to a pixel shader. The pixel shader can be used to render a mask by computing color and attributes of individual resultant pixels in a resultant output. Such attributes include, by way of example and not limitation, translucency, shadowing, bump mapping, a lighting value, and the like. In at least one embodiment, a pixel shader can generate a resultant bitmap in which the added shapes of an input bitmap correspond to holes in the resultant bitmap, and the black regions of the input bitmap correspond to a lesser degree of transparency in the resultant bitmap. The generated bitmap can be overlaid on an existing map, or used to generate a new map, where some regions appear visually brighter than other regions, as shown by map 414.

In accordance with one or more embodiments, edges of regions in a mask can illustrate a gradual transition and/or fade into other regions. For example, regions 408 and 410 can gradually, visually transition into region 412 with a gradual change from the colors of regions 408, 410 to the color of regions 412. Such can be done by employing a suitable filter.

Map 414 constitutes a combination of map 400 and mask 406. Regions 416 and 418 correspond to mask regions 408 and 410, respectively, while region 420 corresponds to mask region 412. As shown on map 414, regions 416 and 418 are visually distinguished from region 420. While still visible, region 420 appears visually dimmer relative to regions 416 and 418, thus drawing the user's attention to regions containing points of interest. Thus, a mask overlaid on top of a map can render regions of interest visually untouched and render regions not of interest visually dimmer, as in the above example. Alternately, a mask can be overlaid on top of a map can render regions of interest visually brighter while rendering regions not of interest visually untouched.

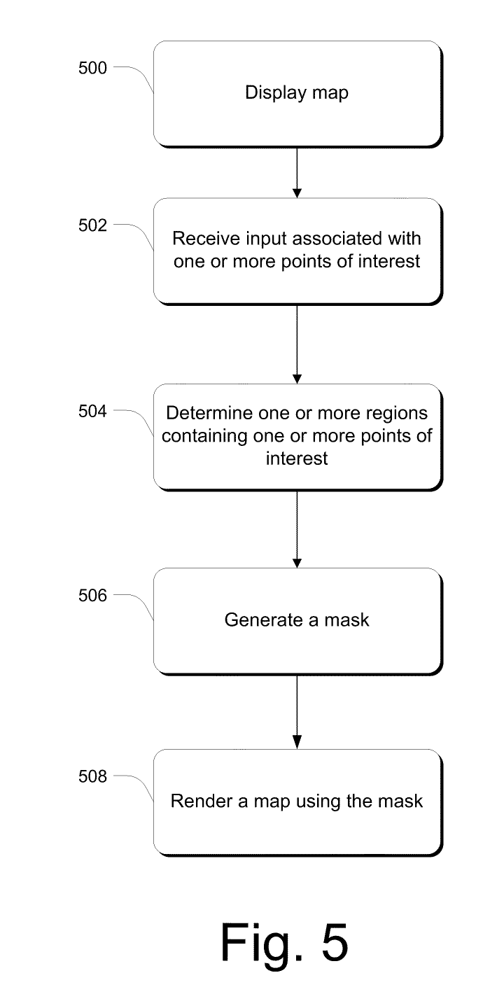

FIG. 5 is a flow diagram that describes steps in a method in accordance with one or more embodiments. The method can be implemented in connection with any suitable hardware, software, firmware, or combination thereof. In at least some embodiments, aspects of the method can be implemented by a suitably configured web browser and/or a software module, such as map spotlighting module 111 (FIG. 1). Alternately or additionally, the method can be implemented by a server that serves web pages.

Step 500 displays a map. This step can be performed in any suitable way. For example, in at least some embodiments, the map can be displayed via a web browser or any other suitable application such as GPS software executing on a computing device. Step 502 receives an input associated with one or more points of interest relative to the map. This input can comprise any suitable type of input, examples of which are provided above.

Responsive to receiving the input, step 504 determines one or more regions, relative to the map, that contain the point(s) of interest. This step can be performed in any suitable way. By way of example and not limitation, the regions can be determined based upon the number of points, the scaling of the displayed map, the proximity of the points to one another, whether regions would overlap, and the like. It is to be appreciated and understood, however, that any suitable technique for determining regions that contain points of interest can be utilized without departing from the spirit of the claimed subject matter. This step can result in single or multiple regions being defined.

Responsive to determining the region(s) containing the point(s) of interest, step 506 generates a mask, relative to the map, having mask regions that correspond to the region(s) of interest, as well as mask regions that correspond to region(s) that are not of interest. Region(s) can be represented by different states of the mask. For example, region(s) on the mask that correspond to region(s) of interest can be represented by an uncovered state of the mask, while region(s) on the mask that correspond to region(s) not of interest can be represented by a covered state of the mask. An example of how this can be done is provided above.

Responsive to generating a mask, step 508 renders a map using the mask. For example, a mask with regions of varying degrees of transparency can be overlaid on an existing map, thus rendering a map with regions of varying visual intensity. In yet another example, a new map can be generated using information from a mask to add or dim the visual brightness of region(s) specified.

Having described how masks can be used to provide a spotlighting effect on a map, consider now a discussion on how graduated intensity of spotlights can be applied to a map.

Graduated Intensity

Various embodiments can provide an ability graduate the visual intensity of regions that contain points of interest. The degree of visual intensity or brightness of a spotlighted region can, in some embodiments, correspond to the region's determined relevance.

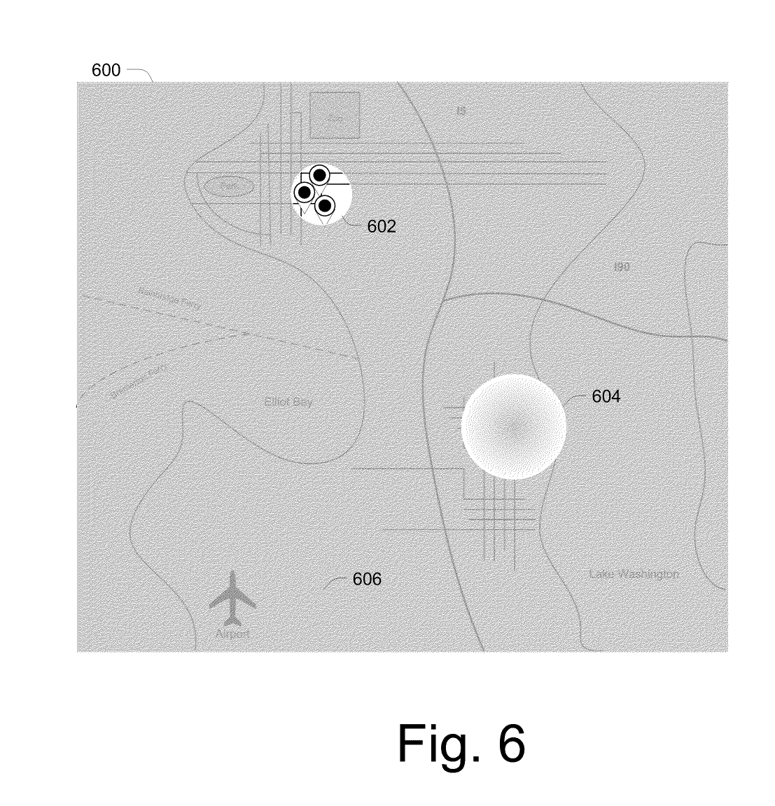

As an example, consider FIG. 6 which illustrates an example map 600 that has three distinct regions 602, 604 and 606. Regions 602 and 604 contain various points of interest related to an input, while region 606 contains no identified points. Of the three regions, region 602 is shown as having the brightest visual intensity. Region 604 has a lesser visual intensity than region 602, but a greater visual intensity than region 606. Region 606 appears the dimmest of the three identified regions.

In this example, region 602 has the most relevance to an associated input, and therefore has the greatest visual intensity. The relevance of a region can be determined in many ways, such as, by way of example and not limitation, by the number of points in a region, the greatest match of a point of interest to a key word comparison with the associated input, the relevance of a region to an advertiser, point(s) in a region associated with the highest positive feedback, and the like.

In one or more embodiments, the visual intensity of region(s) can vary based upon an input parameter. The input parameter can be indicative of any suitable metric. By way of example, and not of limitation, an input parameter can describe the relevance of a region to an input query as in the above example, the popularity hit count of a point(s) at a search engine, the amount of associated positive feedback of a point(s) in a region(s), the degree of family-friendly attributes of a point(s) in the region(s), and the like. Accordingly, the visual intensity applied to a region(s) can be adjusted based upon the input parameter.

In one or more embodiments, a mask can be generated that varies the amount of transparency in one or more regions. Masks can additionally have regions with different degrees of transparency from one another. For instance, a mask can be generated with region(s) of interest having 100% transparency, while region(s) that are not of interest have a lesser degree of transparency. In another example, one region of interest can have 100% transparency, while a second region of interest has 90% transparency, a third region of interest has 80% transparency and a region not of interest has 50% transparency.

Varying the visual intensity of a region can be achieved in several ways. For example, in one or more embodiments, a Gaussian filter can be applied to blur the edges of a region on a mask to alter its effective visual intensity. By applying a filter to graduate a visual transition between region(s) of interest and region(s) not of interest, and/or modifying the span of a transition into a region(s), a variety of visual intensities or brightness, as well as spotlighting sizes, can be achieved. Manipulating characteristics of the filter applied to a region can control the rate of change of a transition between regions, as well as the depth of the transition into a region which, in turn, can control the degree of visual intensity of a region.

In one or more embodiments, spotlights on multiple regions can have varying sizes and visual intensities. The combination of spotlight(s) of various intensities and sizes not only draws a user's attention to region(s) on a map, but can provide the user with at-a-glance information about the region(s).

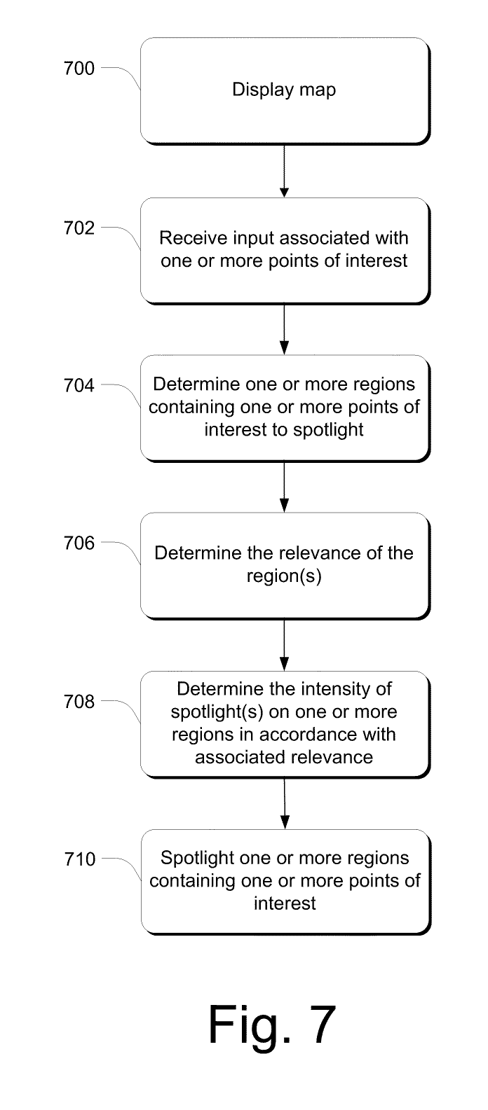

FIG. 7 is a flow diagram that describes steps in a method in accordance with one or more embodiments. The method can be implemented in connection with any suitable hardware, software, firmware, or combination thereof. In at least some embodiments, aspects of the method can be implemented by a suitably configured web browser and/or a software module, such as map spotlighting module 111 (FIG. 1). Alternately or additionally, the method can be implemented by a server that serves web pages.

Step 700 displays a map. This step can be performed in any suitable way. For example, in at least some embodiments, the map can be displayed via a web browser or other application such as GPS software executing on a computing device. Step 702 receives an input associated with one or more points of interest relative to the map. This input can comprise any suitable type of input, examples of which are provided above.

Responsive to receiving the input, step 704 determines one or more regions, relative to the map, that contain the point(s) of interest. This step can be performed in any suitable way. By way of example and not limitation, the regions can be determined based upon the number of points, the scaling of the displayed map, the proximity of the points to one another, whether regions would overlap, and the like. It is to be appreciated and understood, however, that any suitable technique for determining regions that contain points of interest can be utilized without departing from the spirit of the claimed subject matter. This step can result in single or multiple regions being defined.

Responsive to determining the region(s) containing the point(s) of interest, step 706 determines the relevance of the region(s). This can be accomplished in a multitude of ways examples of which are provided above.

Responsive to determining the relevance of a region(s), step 708 determines the visual intensity of spotlight(s) on one or more regions in accordance with the region's associated relevance. Examples of how this can be done are provided above. The visual intensity of region(s) within a map can vary from one another. For example, in one or more embodiments, separate filters with independent characteristics can be applied to each region, resulting in regions with varying degrees of visual intensity.

Step 710 spotlights one or more regions containing one or more points of interest to create a discernable visual distinction between the regions. Examples of how this can be done are provided above.

Having described various embodiments of providing graduated intensity of spotlight(s) on region(s) of a map, consider now an example system that can be utilized to implement one or more of the above-described embodiments.

Example System

FIG. 8 illustrates an example computing device 800 that can be used to implement the various embodiments described above. Computing device 800 can be, for example, computing device 102 of FIG. 1.

Computing device 800 includes one or more processors or processing units 802, one or more memory and/or storage components 804, one or more input/output (I/O) devices 806, and a bus 808 that allows the various components and devices to communicate with one another. Bus 808 represents one or more of any of several types of bus structures, including a memory bus or memory controller, a peripheral bus, an accelerated graphics port, and a processor or local bus using any of a variety of bus architectures. Bus 808 can include wired and/or wireless buses.

Memory/storage component 804 represents one or more computer storage media. Component 804 can include volatile media (such as random access memory (RAM)) and/or nonvolatile media (such as read only memory (ROM), Flash memory, optical disks, magnetic disks, and so forth). Component 804 can include fixed media (e.g., RAM, ROM, a fixed hard drive, etc.) as well as removable media (e.g., a Flash memory drive, a removable hard drive, an optical disk, and so forth).

One or more input/output devices 806 allow a user to enter commands and information to computing device 800, and also allow information to be presented to the user and/or other components or devices. Examples of input devices include a keyboard, a cursor control device (e.g., a mouse), a microphone, a scanner, and so forth. Examples of output devices include a display device (e.g., a monitor or projector), speakers, a printer, a network card, and so forth.

Various techniques may be described herein in the general context of software or program modules. Generally, software includes routines, programs, objects, components, data structures, and so forth that perform particular tasks or implement particular abstract data types. An implementation of these modules and techniques may be stored on or transmitted across some form of computer readable media. Computer readable media can be any available medium or media that can be accessed by a computing device. By way of example, and not limitation, computer readable media may comprise “computer-readable storage media”.

“Computer-readable storage media” include volatile and non-volatile, removable and non-removable media implemented in any method or technology for storage of information such as computer readable instructions, data structures, program modules, or other data. Computer-readable storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

### CONCLUSION

Various embodiments described above enable, in a mapping context, various regions containing points of interest to be spotlighted. In at least some embodiments, a map is displayed on a computing device and points of interest can be located on the map. One or more regions containing the points of interest can be visually spotlighted to draw the user's attention to associated regions.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method comprising:
displaying, with a computing device, a map;
receiving an input defining one or more points of interest to display on the map;
determining one or more regions, relative to the map, that contain the one or more points of interest; and
spotlighting, on the map, the one or more regions that contain the one or more points of interest and not spotlighting one or more regions that exclude the one or more points of interest.

2. The method of claim 1, wherein receiving the input defining one or more points of interest comprises receiving the input from a user.

3. The method of claim 1, wherein the spotlighting comprises varying sizes of multiple spotlighted regions.

4. The method of claim 3, wherein the varying comprises varying the sizes based on relevance of the multiple regions.

5. The method of claim 1, wherein the spotlighting and the not spotlighting comprise rendering the one or more regions that exclude the one or more points of interest visually dimmer and than the one or more regions that contain the one or more points of interest.

6. The method of claim 1, wherein determining the one or more regions that contain the one or more points of interest comprises determining a region based upon the proximity of the one or more points of interest to one another.

7. The method of claim 1, wherein spotlighting comprises fading a spotlight edge into regions that are not spotlighted.

8. One or more computer-readable storage media embodying computer-executable instructions that are executable to:
display, with a computing device, a map;
receive an input defining one or more points of interest to display on the map;
determine one or more regions, relative to the map, that contain the one or more points of interest;
generate a mask in which mask regions that correspond to the one or more regions that contain the one or more points of interest are represented as a first mask state and regions that correspond to regions that exclude the one or more points of interest are represented as a second mask state that is different from the first mask state; and
use the mask to render a map effective to cause the regions that contain the one or more points of interest to appear brighter relative to the one or more regions that exclude the one or more points of interest.

9. The one or more computer-readable storage media of claim 8, wherein instructions that are executable to receive an input comprise instructions that are executable to receive input from a user.

10. The one or more computer-readable storage media of claim 8, wherein the mask comprises a bitmap.

11. The one or more computer-readable storage media of claim 10, wherein the computer executable instructions are executable to input the bitmap to a pixel shader that is used to render the mask.

12. The one or more computer-readable storage media of claim 8, wherein the instructions to generate a mask comprise instructions to apply a filter to graduate a visual transition from the one or more regions that contain the one or more points of interest into the one or more regions that exclude the one or more points of interest.

13. The one or more computer-readable storage media of claim 12, wherein the filter comprises a Gaussian filter.

14. The one or more computer-readable storage media of claim 8, wherein instructions to determine one or more regions comprise instructions to determine the one or more points of interest based upon proximity of the one or more points to one another.

15. One or more computer-readable storage media embodying computer-executable instructions that are executable to:
display, with a computing device, a map;
receive an input defining one or more points of interest to display on the map;
determine one or more regions, relative to the map, that contain the one or more points of interest;
spotlight, on the map, the one or more regions that contain the one or more points of interest, wherein visual intensity of a spotlighted region corresponds to a region's determined relevance.

16. The one or more computer-readable storage media of claim 15, wherein to receive an input defining one or more points of interest is to receive the input from a user.

17. The one or more computer-readable storage media of claim 15, wherein the region's relevance is determined by a number of points of interest in the region.

18. The one or more computer-readable storage media of claim 15, wherein to spotlight comprises fading a spotlight edge into regions that are not spotlighted.

19. The one or more computer-readable storage media of claim 15, wherein the instructions to spotlight comprise instructions to apply a filter to alter visual intensity of the one or more regions.

20. The one or more computer-readable storage media of claim 15, wherein to spotlight comprises varying sizes of multiple spotlighted regions.
